(19) United States
(12) Patent Application Publication
(10) Pub. No.: US 2019/0135315 A1
(43) Pub. Date: May 9, 2019

(54) RAILWAY ASSET TRACKING AND MAPPING SYSTEM

(71) Applicant: Herzog Technologies, Inc., St. Joseph, MO (US)

(72) Inventors: Glen F. Dargy, Shellsburg, IA (US); James W. Hanlon, JR., Grapevine, TX (US); Matthew A. Schouten, Cedar Rapids, IA (US); Lee G. Olson, Cedar Rapids, IA (US)

(73) Assignee: Herzog Technologies, Inc., St. Joseph, MO (US)

(21) Appl. No.: 16/186,075

(22) Filed: Nov. 9, 2018

Related U.S. Application Data
(60) Provisional application No. 62/583,536, filed on Nov. 9, 2017.

(51) Int. Cl. B61L 25/06; G06F 17/30; G06T 7/70

(52) U.S. Cl. CPC B61L 25/065; G06F 17/30241; G06T 2207/10016; G06T 2207/30248; G06T 7/70

(57) ABSTRACT

A railway asset tracking and mapping system stores positions and visual imagery associated with physical railroad assets such as signals, road crossings, platforms, and mile posts along a segment of a railway track and displays the geographic positions and imagery of those physical assets in simultaneous and correlated track chart, video imagery, and map formats on an integrated interactive display. An associated method of displaying correlated track chart, video imagery an map is also disclosed.

### CROSS-REFERENCE TO RELATED APPLICATIONS

This application claims the benefit of U.S. Provisional Patent Application No. 62/583,536, filed Nov. 9, 2017, the disclosure of which is hereby incorporated herein in its entirety by reference.

### BACKGROUND

Railroads regularly inventory their assets, such as rail crossings, signals, bridges and overpasses, mile markers, and the like, for the purpose of tracking, cataloging, and maintaining those assets, as well as for the purpose of determining and cataloging the locations of those physical assets.

The location data of assets with respect to tracks in a rail system is typically compiled and charted into a track chart which schematically depicts various assets along one or more segments of track, presented in a horizontal, linear format. By referring to the track chart as a train travels along the track, an operator of the train can ascertain upcoming crossings, track curvature, or other assets of interest along the segment of track presented in the track chart. Track chart data is most commonly presented as a linear schematic depiction of the track segment as a single horizontal line, with the location of assets along the track segment marked in their approximate relative position to other assets on the line.

In the past, the locations of assets have been recorded primarily based on measured distances from one or more other assets having known locations. Recent improvements in technology, however, allow the determination of more accurate locations of assets. Implementation of Positive Train Control (PTC) under the Rail Safety Improvement Act of 2008 has resulted in the widespread availability and use of global positioning system (GPS) based location data that can more precisely locate railroad assets. For example, U.S. Pat. No. 9,346,476 discloses a track-data verification system and method for verifying the location of railroad assets using GPS technology in compliance with PTC requirements.

Despite the improvements in technology and the availability of highly-accurate positioning data, track charts themselves have remained largely unchanged over the past several decades, with modern-day printed track charts kept in operating locomotives depicting essentially the same information, in essentially the same format, as printed track charts from years ago. As track charts are commonly printed materials, updating of track charts or track chart books often involves hand-written notes by a train operator onto an existing track chart.

Thus, there remains a need in the art for an improved system for tracking and mapping railway assets that provides more detailed and accurate location information for the various physical railway assets, as well as more detailed and accurate presentation of information and data regarding asset location than is possible with conventional track charts.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter. In brief, this disclosure describes, among other things, a system for tracking and mapping railway assets.

In one aspect, the railway asset tracking and mapping system of the present invention stores the positions and imagery associated with physical railroad assets—such as signals, road crossings, platforms, mile posts, and the like—along a segment of a railway track and displays the geographic positions and imagery of those physical assets in simultaneous and correlated track chart, video imagery, and map formats on an integrated interactive display.

The integrated interactive display allows a user of the system to simultaneously: view the assets in their relative relationship to each other on a schematic representation of the track in conventional track chart format, view video imagery of the assets on a video display, and view a map showing the geographic position of the assets, with the simultaneous displays correlated with respect to the position of the assets. Thus, a user viewing a track chart having conventional markings of assets is simultaneously presented with video imagery and map imagery corresponding to a selected point on the track chart, and a user viewing video imagery of a traversal of a portion of track is simultaneously presented with corresponding track chart and map location information.

In another aspect, the system allows a user to sequentially “play” the stored data to simulate traversal of the track segment, with the track chart, video, and map displays simultaneously displaying correlated data corresponding to the changing position along the track. Thus, a user can view or run-through a complete track segment, with the track chart presenting the railway assets in conventional format, the video displaying video imagery of the corresponding railway assets, and the map displaying the corresponding geographic position of the assets as those assets are encountered in the run-through.

In a further aspect, the system can be used for training purposes, providing a train operator with simultaneous views of a track chart, video imagery, and map display of the track, crossings, mile posts, etc. that he or she will be encountering in order to become familiar with the track before actually traversing that segment of track in an actual train.

In yet another aspect, the system allows verification of assets for inventory or maintenance purposes by allowing viewing of recent video of track segments in association with corresponding track chart and map location information.

### DESCRIPTION OF THE DRAWINGS

Illustrative embodiments of the invention are described in detail below with reference to the attached drawing figures, and wherein:

FIG. 1 is a depiction of a track chart displayed by the system in accordance with an exemplary embodiment of the present invention.

FIG. 2 is a screen shot of an interactive display of a track chart and display options, video imagery, and map presented by the system in accordance with an exemplary embodiment of the present invention.

FIG. 3 is a screen shot of an interactive display of a track chart, video imagery, and map corresponding to a first geographical position and orientation presented by the system in accordance with an exemplary embodiment of the present invention.

FIG. 4 is a screen shot of an interactive display of a track chart, video imagery, and map corresponding to a second geographical position and orientation presented by the system in accordance with an exemplary embodiment of the present invention.

FIG. 5 is a screen shot of an interactive display of a track chart, video imagery, and map corresponding to a third geographical position and orientation presented by the system in accordance with an exemplary embodiment of the present invention.

FIG. 6 is a screen shot of an interactive display of a track chart, video imagery, and map corresponding to a fourth geographical position and orientation presented by the system in accordance with an exemplary embodiment of the present invention.

FIG. 7 is a perspective view of an imagery and position acquisition vehicle depicted in accordance with an exemplary embodiment of the present invention.

FIG. 8 is a side elevational view of the imagery and position acquisition vehicle of FIG. 7 depicting view regions of forward and rearward facing sensors of a 360° camera mounted above the vehicle.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about”, “approximately”, or other terms of approximation as used herein denote deviations from the exact value in the form of changes or deviations that are insignificant to the function.

As is known in the railroad industry, mileposts are physical markers positioned adjacent the track, marking a specific physical location along the track, although, despite the name, not necessarily at one-mile increments. Each milepost is typically marked with a number or other identifying indicia. The locations of other railway assets, such as crossings, signals, etc. have traditionally been referenced with respect to one or more mileposts, and that relative relationship between assets and mileposts displayed on traditional track charts.

The geolocation of railway physical assets, such as mileposts, are often obtained by dispatching a vehicle along a length of track segment and capturing video or other depictions of the assets along that segment in conjunction with GPS or other geolocation information associated with those assets.

For example, in an exemplary embodiment of a track verification system as described in U.S. Pat. No. 9,346,476, a GPS unit in conjunction with a positive train control (PTC) system is used to capture video and GPS coordinates of assets as follows. The system of the present invention employs a similar imagery and position acquisition vehicle to acquire video imagery and positions and/or geolocations of assets within view of the vehicle as it traverses a section of railroad track and as captured in conjunction with video imagery of the assets.

While the exemplary embodiment of an imagery and position acquisition vehicle is described herein with respect to the acquisition of 360-degree video imagery data files, it should be understood that the system of the present invention may likewise be used in conjunction with other video imagery capturing devices and/or other video imagery formats. For example, the system may be equally be used with terrestrial video, rail-borne 360-degree spherical imagery, LiDAR point clouds, or with aerial drone imagery files, having associated geographic positional data a video.

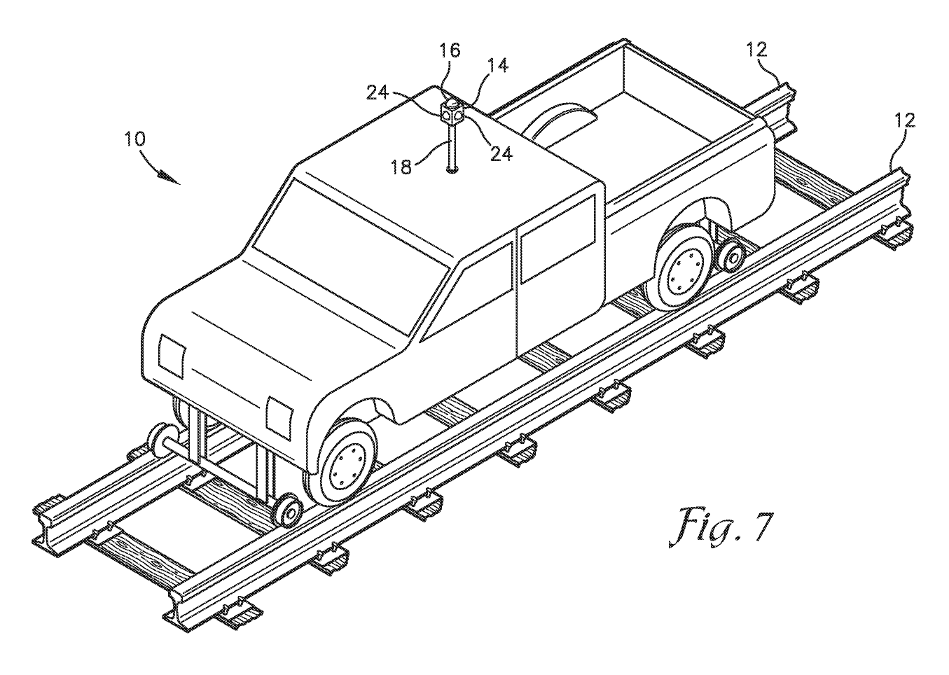

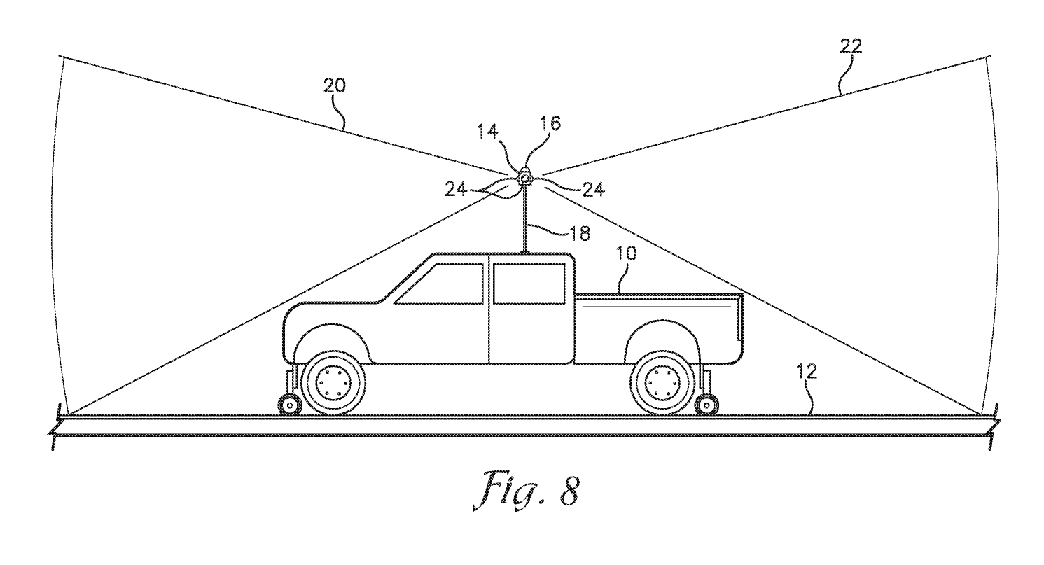

Looking first to FIGS. 7 and 8, an imagery and position acquisition vehicle 10 is depicted in accordance with an exemplary embodiment of the invention. In the depicted exemplary embodiment, the vehicle 10 comprises a standard light-duty pickup truck configured for travel on the tracks or rails 12 of a rail system. Such vehicles are commonly referred to as hirail or hyrail vehicles in reference to their adaption for travel on both highways and rails. However, it should be understood that the vehicle 10 can comprise any vehicle adapted or configured for travel on the rails 12 including, for example, heavy-duty trucks, maintenance vehicles, rail cars, hand cars, locomotives, remote-controlled vehicles, or the like. Vehicle 10 may comprise a crew-cab or five-seat interior configuration, but other configurations can be employed, and other vehicle types may be employed.

One or more of the components of the imagery and position acquisition vehicle 10 may also be disposed on a trailer or rail car that is pulled or pushed by the vehicle 10. All such configurations are within the scope of embodiments of the invention described herein.

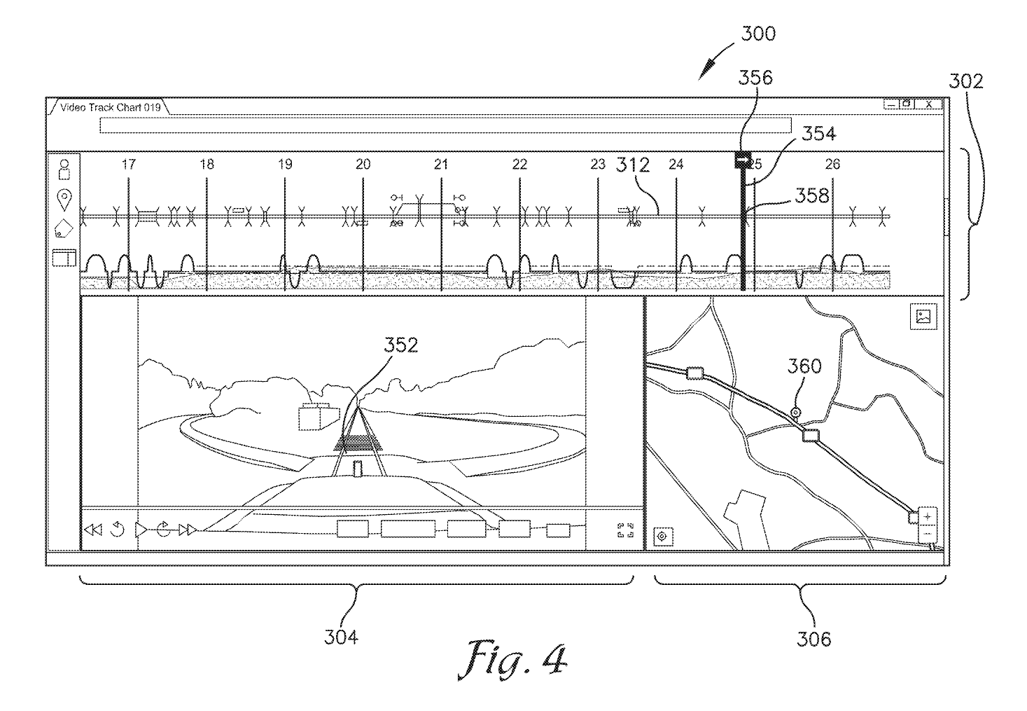

An external camera 14 and a positioning system 16 are mounted on top of the vehicle 10. The external camera 14 is disposed on a support post 18 to provide sufficient height above the vehicle 10 so that the vehicle 10 does not overly obstruct the external camera's view of the ground or objects on or near the ground, as shown best by viewing regions or viewing cones 20 and 22 depicted in FIG. 4.

The positioning system 16 is mounted on top of the external camera 14. The positioning system 16 may alternatively be mounted vertically below or further above the external camera 14 or laterally adjacent thereto. For example, the positioning system 16 may be mounted between left and right facing sensors of the external camera 14 in a single horizontal plane. It is preferable that the external camera 14 and positioning system 16 be co-located along a vertical axis to ensure positional alignment of the camera view with a geographic position indicated by the positioning system 16.

In the exemplary embodiment described, the external camera 14 preferably comprises a 360° camera configured to generate an image that spans 360° horizontally around the external camera 14 and/or the vehicle 10. The external camera 14 preferably includes a plurality of image sensors 24 or an array of cameras that each capture an image from a respective, overlapping viewing region 20, 22, 26, 28 as seen in FIG. 8. The images are preferably combined to produce a single or composite 360° image.

The external camera 14 is preferably configured to capture video but may also be configured to capture still frame images. Other forms and configurations of cameras and combinations thereof that capture 360° views or another viewing angle may be employed in embodiments of the invention without departing from the scope described herein. As discussed above, other image capturing devices and formats, such as terrestrial video, rail-borne 360-degree spherical imagery, LiDAR point clouds, or aerial drone imagery files, all having associated geographic positional data, are within the scope of the present invention.

The positioning system 16 is preferably a precision global positioning system (GPS) unit configured to provide centimeter-level positional accuracy however other more or less precise units may be employed. Other positioning system technologies including the GLONASS system operated by the Russian Aerospace Defense Forces, the Galileo system provided by the European Union and European Space Agency, or the Long Range Navigation (LORAN) hyperbolic radio navigation system developed by the United States, among other satellite-based and non-satellite-based systems can be employed instead of or in addition to GPS. The complete positioning system 16 may be mounted on top of the external camera 14 or only a receiver or antenna portion thereof might be mounted on the external camera 14 while the remainder of the unit 16 is disposed within the vehicle 10 or integrated into a control unit 50 as discussed below. The position reported by the positioning system 16 is the position of the portion of the positioning system 16 that is co-located with the camera 14. Alternatively, the receiver or antenna portion of the positioning system unit 16 may be provided in association with the vehicle 10 with a known offset from the external camera 14. The actual position of the external camera 14 and/or asset(s) to be identified and located can thus be calculated based on the known offset.

In initial use, an imagery and position acquisition vehicle is positioned on the rails of a segment of a rail system for which a plurality of assets are to be identified and located and for which positional data is to be associated.

An operator/driver of the vehicle is positioned in a driver's seat and the imagery and positional acquisitions systems are started and/or initialized. The 360-degree image captured by the external camera is preferably displayed on a monitor for viewing by the operator/driver such that the operation and field of view of the image capturing system can be verified as the vehicle is operated.

As the vehicle is driven along the rails, over a desired section of track, the imagery and corresponding positional information and data is continuously stored, building an imagery file having video imagery and positional data corresponding to the entire traversal of the section of track. In preferred embodiments, the imagery and positional data files captured for numerous sections of track are stored on a central server for access by other vehicles, locomotives, training centers, and the like, as desired. Most preferably, the imagery and positional data files are processed to associate railroad assets identified in the video, such as mile posts, signals, crossings, etc. with locations within the data file so that upon playback of the video file, the identified assets can be correlated with mapping systems and with other identified and located assets.

With an imagery and positional file acquired as just described, including the GPS or other location information with respect to one or more assets along a segment of railway, or with other video imagery files, such as terrestrial video, rail-borne 360-degree spherical imagery, LiDAR point clouds, or aerial drone imagery files, having associated geographic positional data a video, the railway tracking and mapping system of the present invention using such a video imagery file will now be described.

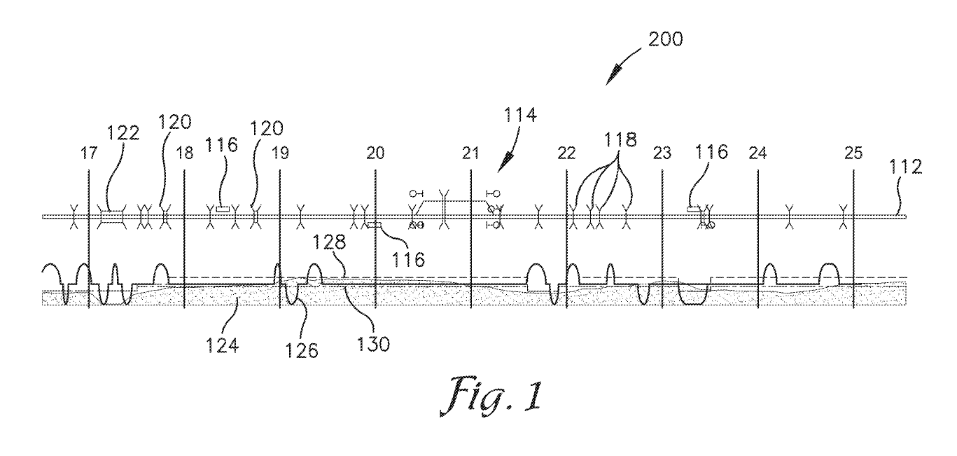

Looking to FIG. 1 a track chart displayed by the railway tracking and mapping system of the present invention using a computer, processor, workstation, server, or other device capable of processing and displaying data, is depicted generally by the numeral 100. The track chart presented by the system is substantially in the form of a conventional printed track chart, depicting a horizontal schematic representation of the relative positions of assets along a segment of railway track with respect to the positions of known physical mileposts. In the exemplary chart depicted, the track 112 is represented by the horizontal line extending across the chart, with the numbered mileposts 17 through 25 represented by vertical lines extending perpendicular to the track 112. Each of the mileposts 17 through 25 represents a like-numbered physical milepost positioned alongside the physical track, with each of those mileposts having a known physical geographic location. Thus, the track chart of FIG. 1 depicts a schematic representation of a physical track extending approximately between physical mileposts 17 through 25. As also seen in the figure, the mileposts 17 through 25 are approximately evenly spaced along the track 112, as are the physical mileposts along the physical track.

Looking still to FIG. 1, the track chart 100 further depicts representations of other physical railway assets located along the track 112, with signals 114 positioned near milepost 21 and platforms 116 positioned near mileposts 18, 20, and 23. Crossings 118 occur at multiple instances along the track 112, bridges 120 positioned near mileposts 18 and 19, and a tunnel 122 positioned near milepost 17. Thus, the upper portion of the track chart 100 depicts schematic representation of various physical railroad assets in approximate relative relationship to other assets and mileposts.

Looking to the lower portion of the track chart 100, the grade 124 and curvature 126 of the track are depicted schematically, showing the corresponding grade and curvature of the physical track at those corresponding locations. Also depicted at the lower portion of the track chart 100 are the recommended maximum speeds of travel for the corresponding section of the track for both passenger and freight trains.

Thus, a train operator viewing the track chart 100 is provided with information about railway assets, mileposts, and track features in a schematic view allowing the operator to anticipate upcoming assets as the train progresses along the path.

It should be understood that the track chart is bidirectional in that regardless of the direction of travel of the train, the train operator can ascertain upcoming mileposts, assets, and track features. It should be further understood that various assets, such as halting features (e.g., signals and platforms), crossing features (e.g., crossings and overpasses), terrain navigation features (e.g., bridges and tunnels), and track information (e.g. grade, passenger train speed, freight train speed, and curvature) may be depicted on the track chart and that additional features may likewise be included, with the depictions on the track chart typically corresponding to a physical asset on or along the segment of track represented.

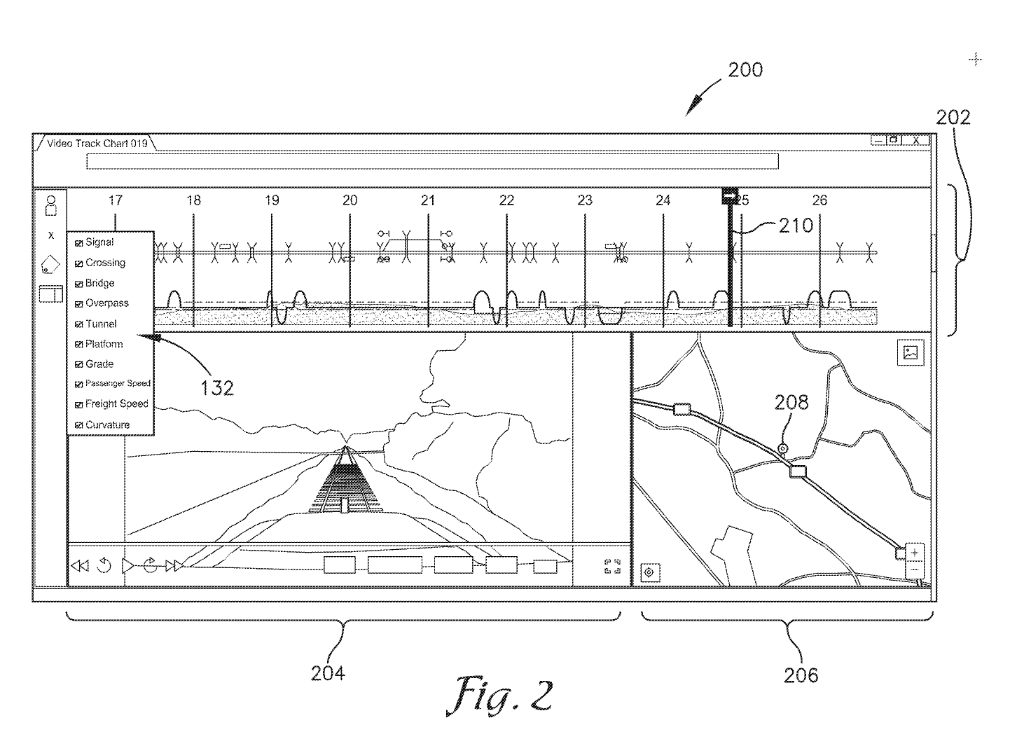

It should be also understood, as will be discussed in more detail below, that a user of the system of the present invention may select any or all of the assets and track information as desired for display on the track chart. Thus, for example, a user may display all of the assets, or may choose to select and display a subset of the assets, such as just the crossing features (crossings and overpasses), or the crossing features and the platforms, or any other desired combination. Thus, as seen in FIG. 2, in an exemplary embodiment of the present invention, the system user is presented with access to a pop-up menu 132 that allows the user select or deselect classes of assets or track features to include or exclude from display on the track chart.

In a manner similar to the association of GPS or other coordinate data with physical assets as just described with respect to the track charts, video files having imagery of the track, assets, and other features along the track likewise include GPS or coordinate data corresponding to the captured image frames. Thus, various types of video imagery files, such as terrestrial video, rail-borne 360-degree spherical imagery, LiDAR point clouds, or aerial drone imagery files, having associated geographic positional data are used in conjunction with the system of the present invention. As will now be described with respect to FIG. 2, the system of the present invention aggregates and correlates the data between the assets and video files, and presents a user with an integrated interactive simultaneous display of track chart, video imagery, and map displays as seen in FIG. 2.

Looking to FIG. 2, a screen display 200 presented to a user by the system of the present invention includes a track chart region 202, a video imagery display region 204 and a map display region 206. The track chart region 202 displays a track chart as described above with respect to FIG. 1, with a pop-up menu 132 to allow the user to select desired assets and features for display. Simultaneously with the display of a track chart, the system displays a corresponding video file in the video imagery display region 204. Coordinating the positional data in the video file with the positional data associated with the assets and features displayed in the track chart, the system of the present invention correlates the position of the displayed video frame with a corresponding position indicator bar 210 on the track chart. Thus, the geographic location of the displayed video image frame corresponds to the geographic location of the track and/or asset depicted on the track chart. Similarly, the map image displayed in the map display region 206 depicts a pin 208 indicating the corresponding map location of the geographic location of the video image frame and the corresponding track and/or asset. Thus, the screen display 200 simultaneously presents three views of the same geographic point of the track and/or asset in three separate formats and views: track chart view, video image view, and map view.

In addition to the static view of a track and/or asset as just described, the system of the present invention further allows play through of an entire sequence of track chart, video imagery, and map displays corresponding to an entire segment of track. Thus, using the interactive display presented by the system, a user can navigate through the video, viewing the track and assets or features in the video, while simultaneously viewing the schematic depiction of that same point on the track on the track chart, and while simultaneously viewing the currently-viewed location on the map display. An exemplary sequence of such a play through and the interactive ability of the system of the present invention will now be described.

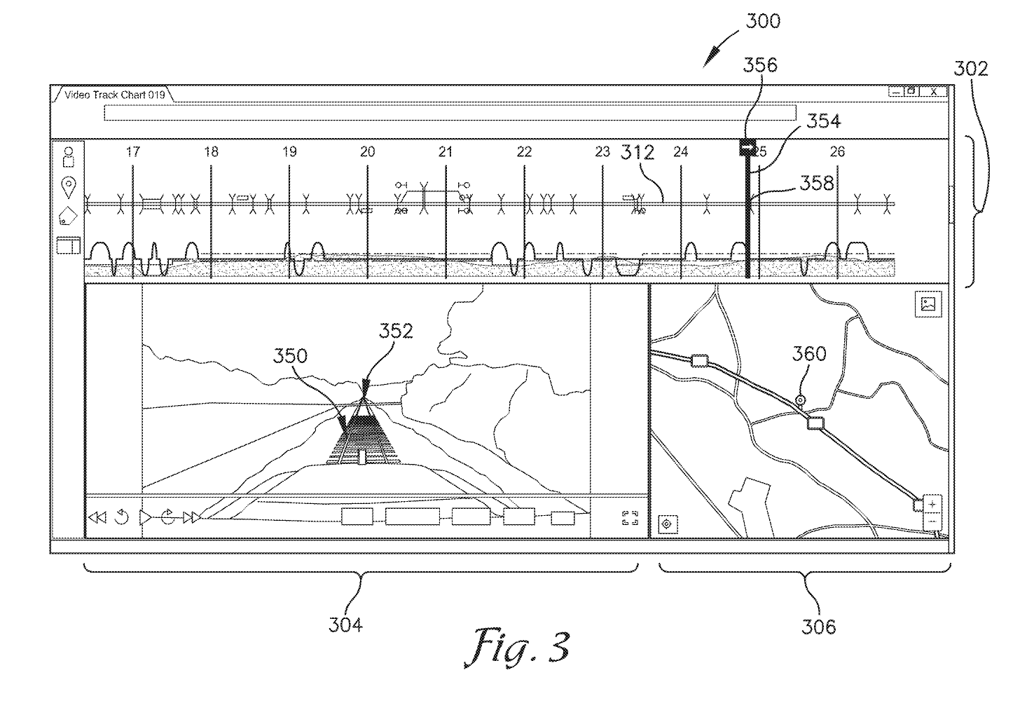

Looking to FIGS. 3 through 7, a sequence of display screens of the system of the present invention depicting the synchronization of geographic positional data between the displayed track chart, video imagery, and map display are depicted. Each display screen includes a track chart region 302 for displaying a schematic depiction of a track 312 extending approximately between mileposts 17 and 26 and various assets and/or track features along that segment of track, a video imagery display region 304 for displaying a video image corresponding to a geographic location, and a map display region 306 for displaying one or more points on a street map display.

Starting at FIG. 3, and looking to the video imagery display region 304, it can be seen that the video image from the front of the train shows the physical track 350 and an upcoming crossing 352 in the near distance. As described above, the system of the present invention correlates the geographic location information of the displayed video image with the geographic location information of the assets and features depicted in the track chart. Thus, looking to the track chart display region 302, the system displays a current position indicator bar 354 showing the current position on the track chart corresponding to the geographic location information provided by the displayed video image file. A direction indicator 356 at the top of the current position indicator bar 354 displays the direction in which the current sequence is being played—i.e., the video can be played in either direction as desired by a user of the system.

As can be seen in FIG. 3, the current position indicator bar 354 and direction indicator 356 on the track chart show that the train is approaching a crossing 358 just a short distance from the current position indicator bar 354—correlating with the image displayed. Thus, the track chart depiction correlates with the displayed image so that a user of the system can visually see the images and data from each simultaneously. Similarly, looking to the map display region 306 of the interactive display, a position pin 360 is displayed at the point corresponding to the geographic location of the displayed image and the position of the current position indicator bar 354 of the track chart.

Thus, the three displays—track chart, video image, and map—simultaneously display various aspects of the track, assets, features, and location to a user of the system.

Continuing the sequence to FIG. 4, as seen in the displayed video image, the train has proceeded to the crossing 352 that was previously in the near distance (in FIG. 3). Looking to the track chart it can be seen that the current position indicator bar 354 has likewise progressed to the depicted crossing 358—thus showing the current position of the train in the displayed video image correlates to the current position indicator bar 354 in the track chart, and that the physical crossing 352 seen in the video image correlates to the depicted crossing 358 in the track chart. Likewise, it can be seen that the position pin 360 depicted in the map display region 306 has moved from its prior position in FIG. 3 to a new position correlating to the changed position of the train as indicated by the geographic location information from the corresponding video image file.

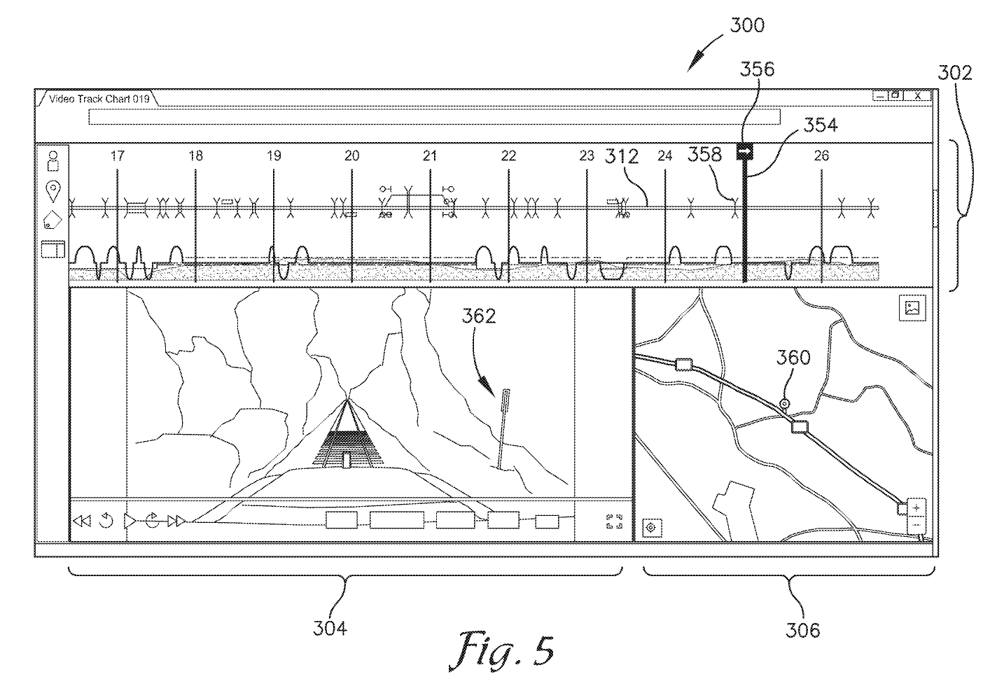

Proceeding to FIG. 5, as seen in the video image, the train has progressed past the crossing of FIG. 4, and is approaching a milepost 362 seen in the right-hand portion of the image. Looking to the track chart, it can be seen that the current position indicator bar 354 is approaching milepost 26—corresponding to the physical milepost 362 seen in the image. Similarly, the position pin 360 on the map display has changed to indicate the current position correlating to geographic location shown in the video image and depicted on the track chart.

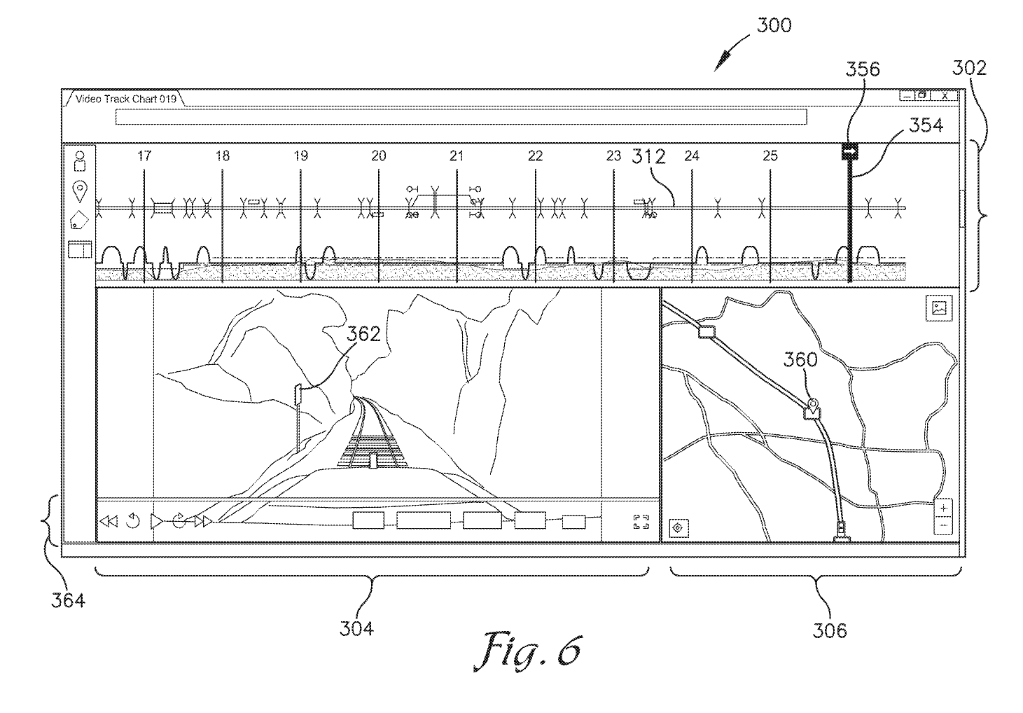

Finally, looking to FIG. 6, as shown by the direction indicator 356, the user has reversed the direction of the playback by clicking on the indicator 356 displayed on the interactive display screen. Thus, as seen in the displayed video image, the physical milepost 362 is now seen on the opposite side of the train, as the video now displays the train approaching the milepost from the opposite direction. As seen in the track chart, the physical milepost correlates to milepost 26 on the track chart. Similarly, the position pin 360 on the map display shows the current position of the train.

As just described, the system of the present invention correlates the geographic positional data of video image files and railway assets and synchronizes and simultaneously displays correlated track chart, video, and map representations of the track and assets. As discussed with respect to FIGS. 3 through 6, the data file may be played through to show a continuous motion video play back in conjunction with track chart and map data that updates in conjunction with the video. As seen in FIG. 6, interaction with the direction indicator 356 allows a user to change the direction of the video playback, with standard video controls 364 presented on the video display allowing a user to pause, fast forward and reverse, and to skip ahead and back during video playback, with the track chart and map displays following and synchronizing with the video.

From the above, it can be seen that the system of the present invention can be employed to correlate the geographic locations of physical railway assets with corresponding video, track chart, and map depictions of those assets.

Many different arrangements and configuration of the system described and depicted, as well as components and features not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

What is claimed is:

1. A method for tracking and mapping physical locations of railway assets, comprising:
providing a vehicle configured for travel on rails of a rail system having assets to be tracked;
capturing, by a video imagery device attached to the vehicle, imagery data corresponding to one or more assets in proximity to the rail system;
acquiring, by a positional data system, positional information associated with the one or more assets;
correlating the positional information associated with at least one of the one or more assets with video imagery associated with that at least one of the one or more assets; and
presenting a track chart format display of a plurality of railway assets in conjunction with a display of imagery associated with a positional reference on the track chart display.

2. The method of claim 1, further comprising:
displaying a map view of a geographic location corresponding to the positional reference on the track chart display in conjunction with the track chart display and the imagery display.

3. The method of claim 1, wherein video imagery corresponding to the positional reference on the track chart display is successively displayed in correlation with movement of the positional reference.

4. The method of claim 3, further comprising displaying a map view of a geographic location corresponding to the positional reference on the track chart display in conjunction with the track chart display and the imagery display, and wherein the map view is successively displayed in correlation with movement of the positional reference.

5. The method of claim 4, wherein the track chart display, the imagery display, and the map display are synchronized to each other such that positional information of each correlates to positional information of each of the others.

6. The method of claim 1, wherein the track chart format display includes user-operable controls allowing selective display of desired railroad assets.

7. The method of claim 1, wherein the video imagery comprises data collected via terrestrial video, rail-borne 360-degree spherical imagery, LiDAR point clouds, aerial drone imagery systems, and combinations thereof.

8. A system for tracking and mapping physical locations of railway assets, comprising:
a vehicle configured for travel on rails of a rail system having assets to be tracked;
a video imagery capture device attached to the vehicle, operable to capture imagery data corresponding to one or more assets in proximity to the rail system;
a positional data system attached to the vehicle, operable to capture positional information associated with the one or more assets;
a processor operable to correlate the positional information associated with at least one of the one or more assets with video imagery associated with that at least one of the one or more assets and to present a track chart format display of a plurality of railway assets in conjunction with a display of imagery associated with a positional reference on the track chart display.

9. The system of claim 8, wherein the processor is further operable to display a map view of a geographic location corresponding to the positional reference on the track chart display in conjunction with the track chart display and the imagery display.

10. The system of claim 8, wherein video imagery corresponding to the positional reference on the track chart display is successively displayed in correlation with movement of the positional reference.

11. The system of claim 10, wherein a map view of a geographic location corresponding to the positional reference on the track chart display is displayed in conjunction with the track chart display and the imagery display, and wherein the map view is successively displayed in correlation with movement of the positional reference.

12. The system of claim 11, wherein the track chart display, the imagery display, and the map display are synchronized to each other such that positional information of each correlates to positional information of each of the others.

13. The system of claim 9, wherein the track chart format display includes user-operable controls allowing selective display of desired railroad assets.

14. The system of claim 1, wherein the video imagery comprises data collected via terrestrial video, rail-borne 360-degree spherical imagery, LiDAR point clouds, aerial drone imagery systems, and combinations thereof.

15. A method for tracking and mapping physical locations of railway assets, comprising:
acquiring video and positional data associated with a plurality of assets in proximity to a section of railway of interest;
correlating positional information associated with at least one of the plurality of assets with video imagery associated with the at least one of the plurality of assets; and
presenting a track chart format display of a plurality of railway assets in conjunction with a display of imagery associated with a positional reference on the track chart display.

16. The method of claim 15, further comprising:
displaying a map view of a geographic location corresponding to the positional reference on the track chart display in conjunction with the track chart display and the imagery display.

17. The method of claim 15, wherein video imagery corresponding to the positional reference on the track chart display is successively displayed in correlation with movement of the positional reference.

18. The method of claim 17, further comprising displaying a map view of a geographic location corresponding to the positional reference on the track chart display in conjunction with the track chart display and the imagery display, and wherein the map view is successively displayed in correlation with movement of the positional reference.

19. The method of claim 18, wherein the track chart display, the imagery display, and the map display are synchronized to each other such that positional information of each correlates to positional information of each of the others.

20. The method of claim 15, wherein the track chart format display includes user-operable controls allowing selective display of desired railroad assets.
